(19) United States
(12) Patent Application Publication
(10) Pub. No.: US 2014/0297922 A1
(43) Pub. Date: Oct. 2, 2014

(54) METHOD AND APPARATUS FOR MANAGING SERIAL PERIPHERAL INTERFACE (SPI) FLASH

(71) Applicants: Nitin V. Sarangdhar, Portland, OR (US); John J. Vranich, West Roxbury, MA (US); Kirk D. Brannock, Hillsboro, OR (US); Steven Dennison, Folsom, CA (US)

(72) Inventors: Nitin V. Sarangdhar, Portland, OR (US); John J. Vranich, West Roxbury, MA (US); Kirk D. Brannock, Hillsboro, OR (US); Steven Dennison, Folsom, CA (US)

(21) Appl. No.: 13/853,429

(22) Filed: Mar. 29, 2013

(51) Int. Cl. G06F 12/02

(52) U.S. Cl. CPC G06F 12/0246
USPC 711/103

(57) ABSTRACT

A system for communicating with a flash device includes: a controller configured for communicating with the flash device, the controller including logic for classifying a command to the flash device as one of safe and unsafe and communicating each safe command. Methods and a computer program product and a computing system are disclosed.

### TECHNICAL FIELD

Embodiments described herein generally relate to methods and apparatus for controlling communications with flash memory.

### BACKGROUND

Serial Peripheral Interface (SPI) flash memory is a vital part of many computing architectures. Accordingly, a number of manufacturers offer SPI flash memory to computer designers and manufacturers. The design and performance of SPI flash memory (also referred to herein as “SPI flash,” as “flash memory” or simply as “flash”) is varied as each manufacturer attempts to present advantageous designs. Considering that flash memory is merely one component of a computing system, ensuring integrity of communication with flash memory may be complicated by system architecture in incorporation of additional components.

### BRIEF DESCRIPTION OF THE DRAWINGS

The features and advantages of the invention are apparent from the following description taken in conjunction with the accompanying drawings in which:

FIG. 1 is an schematic diagram depicting aspects of an exemplary architecture for computing system; and

FIG. 2 is a flow chart providing an exemplary process for communicating with flash memory.

### DESCRIPTION OF EMBODIMENTS

In many architectures, technical problems with flash memory arise when communications are performed by both a platform controller hub (PCH) and an embedded controller (EC). In some embodiments, flash memory is shared between the PCH and the EC. Thus, and by way of example, communications by the embedded controller can interfere with communications through the platform controller hub, thus resulting in system conflicts.

Accordingly, solutions disclosed herein include methods and apparatus for ensuring secure communications with flash devices, such as serial peripheral interface (SPI) flash memory. In general, commands that are to be communicated to flash devices are compared with predetermined command structures. Validated commands are then communicated to the flash devices.

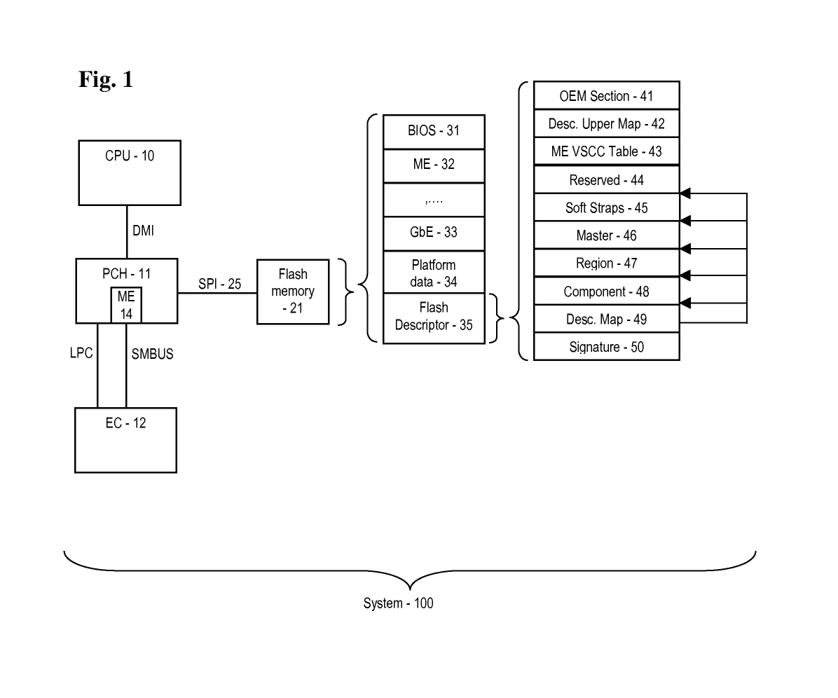

Referring now to FIG. 1, there is shown an overview of aspects of an exemplary and non-limiting architecture for a computing system 100. In this example, the system 100 includes a central processing unit (CPU) 10, a platform controller hub (PCH) 11, an embedded controller (EC) 12 and flash memory 21 (e.g., serial flash memory). Generally, communications with flash memory 21 are through a serial peripheral interface bus (SPI) 25. Included as a part of the platform controller hub (PCH) 11 is a management engine (ME) 14. Generally, the embedded controller 12 and the platform controller hub 11 communicate via at least one of a system management bus (SMBUS) and a low pin count bus (LPC).

The system 100 may include additional components for providing at least one form of an interface. Exemplary components include, at least one of a keyboard, a graphical user interface, a pointing device, a network interface, a printer interface and the like. Other components may be included as well. For example, data storage in the form of magnetic, optical, magneto-optical, and the like, may be included. Other components may be included as well.

Note that as used herein, the term “platform controller hub” and “PCH” refers to specific embodiments of a controller. Generally, the PCH 11 controls certain data paths and support functions used in conjunction with the CPU 10. These include clocking (the system clock), as well as various interface functions. Accordingly, use of “platform controller hub” and “PCH” are to be considered illustrative and are not limiting of the teachings herein. Further, it should be noted that while the teachings herein are presented with regards to flash memory 21, the teachings may be practiced with any form of memory practicable. Exemplary other forms of memory include phase change memory, spin torque memory, NAND, NOR and other similar forms.

As discussed herein, the SPI bus 25 is a synchronous serial data link that operates in full duplex mode. Use of a serial peripheral interface standard, however, is merely an illustrative embodiment of a communications protocol, and is not limiting of communication protocols that may be employed with the teachings herein.

Generally, the flash memory 21 may be any non-volatile memory component that may be electronically erased and reprogrammed. For example, the flash memory 21 may include a basic input/output system (BIOS) region 31, a management engine region 32, a network region 33, a platform data region 34, and a flash descriptor region 35. Generally the flash memory 21 is configured for serial communications and may be also referred to as “serial flash.” A variety of other regions may be configured (as denoted by the ellipsis in FIG. 1).

The flash descriptor 35 may be further divided into various groupings of registers. In this example, the flash descriptor 35 is subdivided into an original equipment manufacturer (OEM) section 41, a descriptor upper map 42, a management engine vendor specific component capabilities section 43, a reserved section 44, a soft straps section 45, a master section 46, a region map section 47, a component section 48, a lower descriptor map 49, and a signature section 50.

Communications with the flash memory 21 are controlled by the platform controller hub (PCH) 11. The PCH 11 facilitates communication between the flash memory 21 and any other coupled device. Communication may be governed by input/output logic. The PCH 11 generally retains a non-transferable and exclusive role of “master” with regards to access of flash memory 21. Accordingly, it may be considered that a “trust boundary” is established to ensure integrity of communications with the flash memory 21. Generally, commands are passed to the PCH 11 which in turn communicates with the flash memory 21.

In this example, the embedded controller (EC) 12 maintains communication flash memory 21 through the PCH 11.

In one embodiment, and as an overview, upon receipt of a command (such as one of an “erase” command, a “read” command and other such commands), the PCH 11 compares the command to known op-codes for commanding the flash memory 21. Operation codes (also commonly referred to as “Op-codes”) that have been identified as at least one of “safe” and “default hardware enabled” are then passed to the flash memory 21, op-codes that have been identified as “unsafe” or “default hardware disabled” are blocked and not permitted access to the system flash memory 21, while remaining op-codes that have neither been identified as “safe” or “unsafe” may be managed on an ad-hoc basis using BIOS enabled or BIOS disabled hardware.

As a matter of convention, and for purposes of discussion herein, it should be considered with regards to a flash device that “a command structure” embodies a set of commands that are available to govern operation of the respective flash device. Accordingly, a flash device may include a command structure for safe operations, and may include an additional command structure for unsafe operations during normal operation. Such unsafe operations may be useful to the flash vendors for legitimate business reasons.

In this embodiment, for example, a plurality of op-codes required for operation of the flash memory 21 may be supported through default hardware available through the PCH 11.

In general, there are four classes of op-codes. Each op-code may be one of: safe default hardware (see Table 1); safe BIOS enabled (see Table 2); unsafe default hardware (see Table 3); and unsafe BIOS enabled (see Table 4).

TABLE 1
Exemplary Safe Default Hardware Op-codes

| Command | Op-Code | Parameters | Description |
|---|---|---|---|
| Write Status Register | 01 | 1 or 2 bytes | Writes 1-2 bytes to status register of serial flash. |
| Page Program | 02 | 3 (or 4 bytes*) of | 1 to 64 bytes write as determined by flash part |
| | | address up to 64 | capabilities and software. |
| | | bytes of data | |
| Read | 03 | 3 or 4 bytes of | Single input read with zero wait states. Output |
| | | address | from the flash is single pin SO (serial out). |
| Read Status Register | 05 | None | Used to read the Flash Device status register. |
| | | | Flash device's status register may be one or more |
| | | | bytes |
| Fast Read | 0B | 3 or 4 bytes of | Single input read with one dummy byte of wait |
| | | address | states. Allows faster frequencies. Output from the |
| | | | flash is single pin SO (serial out). |
| 4 KB Sub Sector Erase | xxH | 3 or 4 bytes of | Sets one 4 KB sector to all ‘0xFF’ in main flash |
| | (Through | address | array. Flash device must block this command if |
| | SFDP | | the WEL (Write Enable Latch) bit is not set. |
| | Table) | | Flash devices automatically truncate lower |
| | | | address bits to align the erase to a 4 KB |
| | | | boundary. |
| Dual Output Fast Read | 3B | 3 or 4 bytes of | Single input, dual Output fast (DOFR) read with |
| | | address | one dummy byte of wait states. Output from the |
| | | | flash is driven on two pins, SO and SI. |
| Read SFDP | 5A | 3 | Protocol to detect flash capabilities as defined by |
| | | | JEDEC JESD216 standard |
| Read JEDEC ID | 9F | | Parameters cannot return anything other than |
| | | | information defined by JEDEC spec. |
| 64 KB Sector Erase | xxH | 3 or 4 bytes of | 64 Kbyte Sector Erase. Flash devices |
| | (Through SFDP | address | automatically truncate lower address bits to align |
| | Table) | | the erase to a 64 KB boundary |
| Dual IO Fast Read | xxH | 3 or 4 bytes of | Single input op-code, dual input address, dual |
| | (Through | address | output fast read with discoverable wait states. |
| | SFDP | | Output from the flash is driven on two pins, SO |
| | Table) | | and SI. |
| Quad Output Fast | xxH | 3 or 4 bytes of | Single input, quad Output fast (QOFR) read with |
| Read | (Through SFDP | address | discoverable wait states. Output from the flash is |
| | Table) | | driven on four pins, SO, SI, IO2, and IO3. |
| Quad IO Fast Read | xxH | 3 or 4 bytes of | Single input op-code, quad input address, quad |
| | (Through | address | output fast read with discoverable wait states. |
| | SFDP | | Output from the flash is driven on four pins, SO, |
| | Table) | | SI, IO2, and IO3. |

TABLE 2
Exemplary Safe BIOS Enabled Op-Codes

| Command | Op-Code | Parameters | Description |
|---|---|---|---|
| Read Data | 03h | 3 (or 4 bytes*) of | Read data from main flash array. Data is returned |
| (1-1-1) | | address | immediately after address phase is complete. This |
| | | | op-code must only provide data from the flash array. |
| Write Disable | 04h | None | Disables WEL bit in status register |
| Write Enable | 06h | none | Enables WEL bit in status register |
| Enter Deep | xxH | | Enable Deep Power Down |
| Power Down | (Through | | |
| | SFDP | | |
| | Table) | | |
| Release from | xxH | | Release from Deep Power Down |
| Deep Power | (Through SFDP | | |
| Down | Table) | | |
| Read | 15h | none | |
| Configuration | | | |
| Register | | | |
| Read ID | 90h | none | Read device identification number |
| Reset Enable | 66h | none | |
| Reset | 99h | none | |

Table 2 presents exemplary op-codes that are safe and issued by the BIOS. That is, this table illustrates exemplary op-codes that may be necessary for communication with the flash memory 21 for OEM customization. In some embodiments, an appropriate table that includes information such as presented in Tables 1 and 2 is maintained by the PCH 11. As a matter of convention and for purposes of the discussion herein, such a table that is maintained by the PCH 11 is referred to as a “safe op-codes table.” The safe op-codes table may be maintained by another component, such as a component in communication with the PCH 11, or a subcomponent of the PCH 11. However, for purposes of discussion herein, it is simply considered that the safe op-codes table is maintained by the PCH 11.

Information included in the safe op-codes table may be programmed by BIOS and stored for access by the PCH 11. For example, a vendor of the flash memory 21 may provide a complete list of op-codes applicable to the respective flash memory 21. A subset vendor list of op-codes may then be used by a manufacturer of the PCH 11 to build the safe op-codes table. In some embodiments, the PCH 11 may determine or supplement content for the safe op-codes table by interrogating the flash memory 21. In some embodiments, the PCH 11 may receive the safe op-codes table from BIOS.

In another embodiment, the PCH 11 interrogates the system flash 21 (for example, upon boot-up of the system 100) and identifies unsafe op-codes for operation of the flash memory 21. Upon receipt of a command from the CPU 10, the PCH 11 correlates an appropriate op-code with the command. Again, op-codes that have been identified as at least one of “safe” and “required” are then communicated to the system flash 21, op-codes that have been identified as “unsafe” are blocked and not permitted access to the system flash 21, while remaining op-codes that have neither been identified as safe or unsafe (i.e., benign) may be managed on an ad-hoc basis.

Operations that are recognized as “safe,” “unsafe” or “to be determined” may be classified as such according to at least one of the respective command, a respective op-code, a behavior or as otherwise deemed appropriate.

Exemplary unsafe op-codes include, for example, op-codes that: violate non-bypassability requirement; are destructive to information in the flash array other than sector/subsector erase (e.g., chip erase (C7H r 60H) or a data write that does not use the 02h op-code); change operation of the flash part where it is no longer compatible with the PCH 11. For example, this includes: entering modes where the PCH 11 and SPI bus 25 are not in-sync or in the same mode. More specifically, and merely as examples, when entering 2-2-2/4-4-4 mode, respectively or when entering 32 bit address mode, (Op-code=B7) in client PCH. Op-codes that are deemed to be unsafe may be maintained in a “blocked op-codes table.” The blocked op-codes table may be structured, maintained and managed in a similar manner as described for the safe op-codes table.

That is, the blocked op-codes table may be at least partially populated in advance, and may be supplemented or populated upon boot-up of the system 100. The blocked op-codes table may be maintained by another component, such as a component in communication with the PCH 11, or a subcomponent of the PCH 11. However, for purposes of discussion herein, it is simply considered that the blocked op-codes table is maintained by the PCH 11.

Table 3 presents exemplary unsafe default hardware op-codes, while Table 4 presents exemplary unsafe BIOS enabled op-codes.

TABLE 3
Exemplary Unsafe Default Hardware Op-Codes

| Command | OP-CODE | Parameters | Description |
|---|---|---|---|
| Sub sector erase | 21 | 4 byte address | Subsector erase with |
| | | | 4-byte address |
| Program OTP | 42 | | Program OTP |
| Chip erase | 60 | None | Chip erase |
| Bulk Write | 60 | | Bulk Write |
| Continuously | AD | | Continuously program |
| program mode | | | mode |
| Bank register | B9 | | Bank register Access |
| Access | | | |
| Die Erase | C4 | | Die erase applicable only |
| | | | for stacked devices |
| Bulk Chip Erase | C7 | | Bulk chip erase |

TABLE 4
Exemplary Unsafe BIOS Enabled Op-Codes

| Command | OP-CODE | Parameters | Description |
|---|---|---|---|
| Enter 2-2-2 mode | xxH | | Enter mode where opcode, |
| | (Through | | address, and data are |
| | SFDP | | transmitted over 2 wires |
| | Table) | | |
| Quad Input | 12 | 3 or 4 byte | |
| Extended Fast | | address | |
| program | | | |
| Bank Register | 17 | | |
| Write | | | |
| Quad Input fast | 32 | 3 or 4 byte | |
| program | | address | |
| Quad Input fast | 34 | 4 byte address | |
| program 32-bit | | | |
| address | | | |
| Enable QPI | 35 | | |
| Single Block | 36 | | |
| Lock | | | |
| Quad Input | 38 | 3 or 4 byte | |
| Extended Page | | address | |
| Program | | | |
| enter parallel | 55 | | |
| mode | | | |
| write protection | 68 | | |
| selection | | | |
| set burst with | 77 | | |
| wrap | | | |
| write volatile | 81 | | |
| configuration | | | |
| register | | | |
| dual input fast | A2 | 3 or 4 byte | |
| program | | address | |
| high performance | A3 | | |
| enable mode | | | |
| PPB lock bit | A6 | | |
| write | | | |
| enter secured | B1 | | |
| OTP | | | |
| increase address | C2 | | must only be performed by |
| width to 4 bytes | | | hardware so that hard- |
| | | | ware and flash device are |
| | | | always in sync |
| write extended | C5 | | |
| address register | | | |
| switch device to | C9 | | |
| DDR mode | | | |
| select a die in the | CA | | |
| stack | | | |
| dual input | D2 | 3 or 4 byte | |
| extended fast | | address | |
| program | | | |
| dual input page | D3 | 3 or 4 byte | |
| write | | address | |
| quad input page | D7 | 3 or 4 byte | |
| write | | address | |
| DYB write | E1 | | |
| PPB program | E3 | | |
| PPB erase | E4 | | |
| Write Lock | E5 | | |
| Register | | | |
| Password Write | E8 | | |
| Exit 4 byte | E9 | | must only be performed |
| addressing | | | by hardwareso that |
| | | | hardware and flash device |
| | | | are always in sync |

Simply stated, the PCH 11 may maintain a “white list” (i.e., safe op-codes table) of safe op-codes, as well as a “black list” (i.e., unsafe op-codes table) of forbidden op-codes. In general, an exemplary white list, or safe op-codes table, may include op-codes of Tables 1 and 2. An exemplary black list, or unsafe op-codes table, may include op-codes of Tables 3 and 4. Note that the exemplary op-codes presented in Tables 1 through 4 are merely illustrative and are not limiting. That is, additional op-codes may be included in any one or more of the foregoing tables. In addition, the classification of the listed op-codes represent one embodiment of classification of op-codes. In other embodiments, similar op-codes may be expressed. In some embodiments, it may be appropriate to reclassify at least one of the foregoing op-codes.

Op-codes that are neither a part of the safe op-codes table nor the blocked op-codes table are considered benign op-codes. Generally, the system 100 will test benign op-codes for conformity with certain rules. A first rule includes having full documentation of each respective op-code (i.e., behavior of the respective benign op-code is known and may be maintained in a benign op-codes table). Documentation for a benign op-code may include, for example behavior, type, number of parameters and cycle definition. Another rule includes prohibition of undocumented functionality. Generally, an op-code which is not properly documented is considered unsafe.

In some embodiments after the list of BIOS enabled white list register initialization is completed the registers must be locked before exiting the BIOS. In some embodiments the HW initialized black list registers are initialized by HW power up sequence and is not allowed to change any time during the operation of the platform.

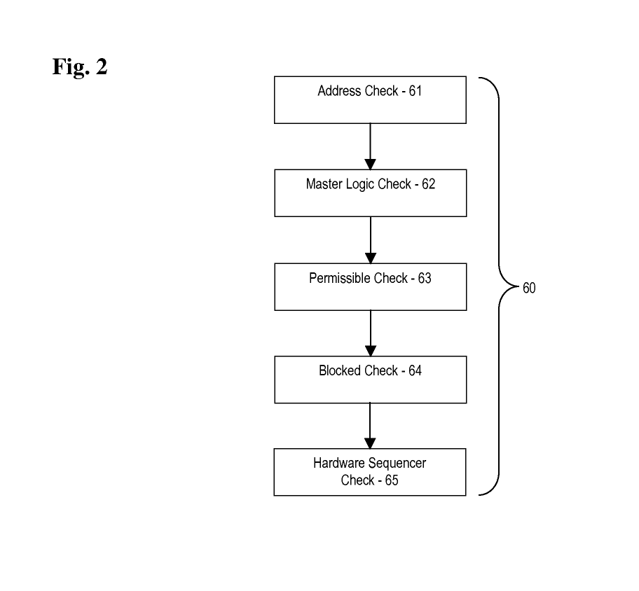

Referring now to FIG. 2, there is shown an exemplary method for communicating 60 with the flash memory 21. In a first step 61, an address check is performed. That is, upon receipt of a command, the PCH 11 will examine the command to associate and validate a designated address of the command with an address in the flash memory 21. More specifically, and by way of example, a command that is to be associated with a region of the flash memory 21, such as the network region 33, is prevented from being accessed by any master other than the network region 33. In a second step 62, a master logic check is performed. The master logic check may evaluate the command for conformity with system rules. In a third step 63, the PCH 11 will compare the received command against the safe op-codes table. If the command is associated with a safe op-code, the PCH 11 will continue processing the command. In a fourth step 64, the PCH 11 will compare the received command against the blocked op-codes table. If the command is not associated with a blocked op-code, the PCH 11 will continue processing the command. If a command could be issued through the hardware sequencer then the command is prohibited from being directly issued. Such commands are only allowed to use the hardware sequencer.

Having thus introduced methods and apparatus for ensuring secure communication with the flash memory 21, some additional aspects are now discussed.

In order to ensure integrity of design, rules may be applied to architecture of the system 100 (specifically, to a “motherboard” that generally includes components discussed in FIG. 1, as well as additional components). For example, in some embodiments, the motherboard must connect logic pins directly between pins of the PCH 11 and the SPI bus 25. These include CLOCK, CS, I01, IO2, I03, and IO4. All signals may be constrained to a voltage between about 0 volts to about VCC (3.3 volts or 1.8 volts as per the flash specification), plus or minus about 10%. Additional rules may require that the GND pin must be connected to the ground plane; the VCC pin must be connected to a voltage plane that operates between about 0 volts to about 3.3 volts or 1.8 volts as per the flash part specification, plus or minus about 10%. Some motherboard implementations may put PCH SPI controller pins under tri-state during RESET and take ownership of the flash memory 21. This may be forbidden to avoid overwriting any protection offered by the PCH SPI controller during RESET. Another rule may require that vendors of the flash memory 21 identify unsafe op-codes for incorporation into the blocked op-codes table. Further, it may be required that the PCH SPI controller ever forward the blocked op-codes on the SPI bus 25. Exemplary codes may include: chip erase; auto increment/execute in page modes; address paging mode; bit transition modes; and communication protocol transitions (from 1-x-x to 2-x-x, and the like).

Further, architecture of the system 100 may be constrained to prevent operation of undocumented functionality. For example, the system 100 may be constrained to prevent flash memory 21 from running undocumented modes, and use of associated command structures.

Further, system architecture may impose rules on firmware of the system 100. In some embodiments, firmware does not program the right status register to issue flash protection capabilities such as one-time programmability, or block protection. Additionally, in some embodiments, firmware does not change the operation of the flash memory via status register such as XIP (execute in place), 4-4-4 or 2-2-2 wire modes. In some additional embodiments, firmware must not set the quad enable bit to “0.” It may be required that firmware only uses required op-codes earlier in communications. In some embodiments, it may be required firmware must not allow block op-codes to be added to a menu of allowed software sequenced operations. Further, in some embodiments it may be require that firmware must not perform any write operation that would cross an address boundary (that is, page over or roll around is prohibited. Additionally, it may be required that flash array data may be stored in a linear address fashion (within a range of 0 to flash_size −1). Subsequent read operations may be required to use the same addressing. Further, wraparound of the write page boundary may be forbidden.

Additionally, system architecture may impose rules on a controller for the flash memory 21. For example, rules may require that the PCH 11 implement op-code and address verification before a command is communicated. Hardware verification may follow rules such as: verification that a requester has permission to read or write a requested address range; checking for at least one of safe, unsafe and benign op-codes; verification of communication protocols; verification of linear addressing mode; and, restriction of software sequencing.

Implementation of the teachings herein generally provides for compliance with security guidelines for preventing unauthorized modification of built-in-operating-system (BIOS) firmware on personal computer (PC) client systems. One exemplary standard has been published by the National Institutes of Standards Technology (NIST) as a draft document, and is entitled “Basic Input/Output System (BIOS) Protection Guidelines,” reference SP 800-147.

Techniques described herein may therefore provide a secure way for a computing platform to communicate with flash memory (e.g., Serial Peripheral Interconnect (SPI) flash memory)without allowing a diversity of components to become part of the platform trusted computing base. For example, embedded controllers may be treated as slave devices that are required to accept their code and data as part of power up programming, wherein the platform may function before the embedded controllers have access to regular firmware. Thus, cost savings associated with offloading the storage of embedded controller code and data to shared flash can be achieved without posing security and privacy risks to the platform.

In one embodiment, a system for communicating with a flash device is disclosed. The system includes: a controller configured for communicating with the flash device, the controller including logic for classifying a command to the flash device as one of safe and supported by default hardware, safe and enabled by BIOS enabled hardware, unsafe and blocked by default hardware and unsafe and blocked by BIOS enabled hardware, and communicating each command that is safe to the flash device.

In another embodiment, a method for communicating with a flash device is provided. The method includes: receiving at least one command for the flash device; verifying an appropriate address of the flash device for each command; classifying each command as one of safe or unsafe; and communicating each command that is safe to the flash device.

In yet another embodiment, a method for blocking communications with a flash device is provided. The method includes: receiving at least one command for the flash device; identifying an inappropriate address of the flash device for any received command; classifying each command as one of safe or unsafe; and blocking communication of each command that is one of improperly addressed and unsafe.

In a further embodiment, a computer program product including machine executable instructions stored on machine readable media, the instructions for communicating with a flash device, by implementing a method is provided. The method includes: receiving at least one command for the flash device; verifying an appropriate address of the flash device for each command; classifying each command as one of safe or unsafe; and communicating each command that is safe to the flash device.

Additionally, an embodiment of a computing system is disclosed. The computing system includes: a platform controller hub (PCH) configured for communicating with a flash memory, the PCH including logic for classifying a command to the flash device as one of safe or unsafe and communicating each command that is safe.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Embodiments of the present invention are applicable for use with all types of semiconductor integrated circuit (“IC”) chips. Examples of these IC chips include but are not limited to processors, controllers, chipset components, programmable logic arrays (PLAs), memory chips, network chips, and the like. In addition, in some of the drawings, signal conductor lines are represented with a single line. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Exemplary sizes, models, values and/or ranges may have been given, although embodiments of the present invention are not limited to these examples. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments of the invention. Further, arrangements may be shown in block diagram form in order to avoid obscuring embodiments of the invention, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments of the invention, it should be apparent to one skilled in the art that embodiments of the invention can be practiced without, or with variation of, these specific details. The description is thus to be regarded as illustrative instead of limiting.

Some embodiments may be implemented, for example, using a machine or tangible computer-readable medium or article which may store an instruction or a set of instructions that, if executed by a machine, may cause the machine to perform a method and/or operations in accordance with the teachings disclosed herein. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within memory of the computing system, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal, chronological, positional or other relational significance unless otherwise indicated.

Various other components may be included and called upon for providing for aspects of the teachings herein. For example, additional components, combinations of components and/or omission of components may be used to provide for added embodiments that are within the scope of the teachings herein.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for communicating with a flash device, the system comprising:
a controller configured for communicating with the flash device, the controller comprising logic for classifying a command to the flash device as one of safe and unsafe and communicating each safe command to the flash device.

2. The system as in claim 1, wherein the controller comprises a platform controller hub.

3. The system as in claim 1, wherein communication of an unsafe command is blocked by the controller.

4. The system as in claim 1, further comprising at least one pre-programmed table comprising at least a portion of a command structure.

5. The system as in claim 1, wherein the controller is configured to query the flash device for at least a portion of a command structure.

6. The system as in claim 1, wherein the controller is configured to receive commands from an embedded controller.

7. A method for communicating with a flash device, the method comprising:
receiving at least one command for the flash device;
verifying an appropriate address of the flash device for each command;
classifying each command as one of safe and unsafe; and
communicating each safe command to the flash device.

8. The method as in claim 7, wherein the verifying comprises comparing a command address with a map of the flash device.

9. The method as in claim 7, wherein classifying comprises comparing a respective command to a command structure for the flash device.

10. The method as in claim 9, wherein the command structure has been pre-programmed.

11. The method as in claim 9, further comprising querying the flash device for at least a portion of the command structure.

12. A method for blocking communications with a flash device, the method comprising:
receiving at least one command for the flash device;
identifying an inappropriate address of the flash device for any received command;
classifying each command as one of safe and unsafe; and
blocking communication of each command that is one of improperly addressed and unsafe.

13. The method as in claim 12, wherein identifying comprises comparing a command address with a map of the flash device.

14. The method as in claim 12, further comprising blocking communication of a command for changing a communications protocol.

15. The method as in claim 12, further comprising blocking communication of a command for software sequencing.

16. The method as in claim 12, further comprising blocking address wrap-around.

17. A computer program product comprising machine executable instructions stored on machine readable media, the instructions for communicating with a flash device, by implementing a method comprising:
receiving at least one command for the flash device;
verifying an appropriate address of the flash device for each command;
classifying each command as one of safe and unsafe; and
communicating each safe command to the flash device.

18. The product as in claim 17, where in the media comprises at least one of an integrated circuit, a chip, a chipset, a controller, magnetic media, optical media, and removable media.

19. A computing system comprising:
a user interface configured for receiving an input from a user;
a central processing unit for processing the input and providing at least one command; and
a controller configured for exclusively communicating with a memory, the controller comprising logic for classifying a command to the memory as one of safe and unsafe and communicating each safe command.

20. The computing system as in claim 19, the controller further comprising logic for blocking commands that do not conform to a set of rules.
